(19) United States
(12) Patent Application Publication
(10) Pub. No.: US 2002/0041922 A1
(43) Pub. Date: Apr. 11, 2002

(54) Fruit or vegetable juice processing and packaging facility

(76) Inventors: Herbert W. Fiss, Bradenton, FL (US); W. Hayden Sayce, East Sussex (GB)

Correspondence Address: Charles J. Prescott, P.A., Suite 115, 2033 Wood Street, Sarasota, FL, 34237, US

(21) Appl. No.: 10/012,917

(22) Filed: Dec. 10, 2001

Related U.S. Application Data
(63) Continuation-in-part of application No. 09/484,546, filed on Jan. 18, 2000.

(51) Int. Cl. A23L 2/00

(52) U.S. Cl. 426/399; 426/615; 426/599

(57) ABSTRACT

A one-site fruit or vegetable processing and packaging facility and method of processing, packaging, and shipping blended juices and juice concentrates. A single extended enclosure is provided within which the facility equipment and associated functions are housed. The facility further includes stages, preferably in seriatim, for (a) receiving raw fruit or vegetables, (b) crushing the fruit or vegetables into a mash, (c) extracting juice from the mash, (d) juice pasteurizing and aroma essence stripping to produce aseptic juice, (e) microfiltration of the aseptic juice and (f) removing excess water from aseptic juice making a concentrated aseptic juice. The concentrated aseptic juice is either placed into bulk shipment containers ready for shipment or blended with separate fruit or vegetable juice concentrates separately received and stored in the facility to produce a desired blended juice with high uniformity and consistency. The blended juice is either sterilized and maintained at a preselected cold-ambient fill temperature or sterilized and maintained at preselected temperature. Each blended juice is then simultaneously and continuously packaged into predetermined self-stable containers ready for shipment.

### BACKGROUND OF THE INVENTION

### SCOPE OF INVENTION

This invention relates generally to the processing of fruit and vegetables into juice, and more particularly to a one-site facility within which substantially all of the equipment and steps of fruit processing are housed.

### PRIOR ART

The industry and technology of processing fruit and vegetables into concentrates and blended juices includes well-known individual steps and equipment for accomplishing each of the stages or steps in the fruit processing chain of events. Moreover, the fruit and vegetable processing industry has evolved into having only portions of the entire process being accomplished at a single location.

That is to say that one entity may harvest fruit or vegetables and deliver same to another facility which accomplishes a portion of the overall steps toward the shipment of a concentrate or the packaging and shipment of preselected blended juices. Typically, after the fruit or vegetables have been partially processed, it is shipped to yet another location for further processing, purification, filtration, containerizing the partially processed juice for shipment to a final destination which may then accomplish the blending and final packaging for consumer consumption.

Armed with substantial experience and expertise, applicants are unaware of any prior art facility or processing in this industry which is substantially self-sufficient in that all of the steps of fruit handling from receiving the raw fruit to the simultaneous multi-blends packaging and shipment of juice concentrates and blended juices for direct human consumption are completed therein. Applicants are aware of the teaching in JP 362065669A by Tanabe which does teach a one-site fruit processing and packaging facility to produce sterile juice under complete automatic control. However, the simultaneous packaging of a wide variety of blended juices is quite unique with respect to the present invention and as it is integral to a complete one-stop fruit and vegetable juice processing facility.

One of the features of the present invention is that it provides an automatic control production chain from receiving fruit or vegetable shipments to packaging all concentrates and blends at a single location and within one plant facility structure. The present invention also enables a manufacturer to produce final juice products under a complete and controlled aseptic environment which begins at the point where the juice itself is filtered in preparation for evaporation and continuing until the final packaging of either the concentrate or the blended juices is accomplished.

By providing a single plant facility, selected and quality controlled juice concentrates and blended fruit or vegetable juices may be dealt with commercially based upon a single all inclusive purchase order from customers of juice products produced within the present invention. Additionally, the present invention offers a substantially wider range of final juice products for distribution such as fruit juice concentrates either packed in bulk or for consumer use, blended juices, both concentrated and ready for consumption, along with single strength fruit or vegetable juices packaged in a wide variety of commercial containers. All this is accomplished automatically within the one-site facility of the present invention to satisfy the broadest range of purchase order variety and at considerably less expense and in the shortest and quickest deliver times yet seen in this industry.

### BRIEF SUMMARY OF THE INVENTION

This invention is directed to a one-site fruit or vegetable processing and packaging facility and method of processing, packaging, and shipping blended juices and juice concentrates. A single extended enclosure is provided within which the facility equipment and associated functions are housed. The facility further includes, preferably in seriatim, a fruit or vegetable shipment receiving area for receiving shipments, crushing equipment for crushing the fruit or vegetable into a mash, a juice extraction station for extracting juice from the mash by preheating, enzyme treating and depectizing juices from the mash, juice pasteurizing and aroma essence stripping to produce aseptic juice, microfiltration of the aseptic juice, and an evaporative juice concentration stage to remove and preferably recover and recycle excess water from aseptic juice into a concentrated juice. A portion of concentrated aseptic juice is typically then placed into bulk shipment containers ready for shipment. A remaining portion of concentrated aseptic juice is blended with separate juice concentrates separately received and stored in the facility for producing a desired blended juice with high uniformity and consistency. A portion of blended juice is sterilized and maintained at a preselected cold-ambient fill temperature while another portion of the blended juice is sterilized and maintained at preselected temperature. Each blended juice is then simultaneously and continuously packaged in multiple packaging stations into predetermined self-stable containers ready for shipment. It is therefore objects of the present invention to provide a one purchase order “one stop shop” plant facility offering the following customer benefits:

1. Controlled fruit or vegetable juice and concentrate product quality;

2. Monitoring of product quality at every stage of juice concentrate and in blended form to insure maximum quality and consistency of product;

3. Maintaining customer product to a consistently exact quality standard desired by each customer, as well as consistently meeting the standards of USDA, and the USF&DA;

4. More competitive product pricing as a result of minimizing the negative effects of multiple sources of supplies, channels and handling by middle men, agents and brokers through which product ingredients and final product have traditionally flowed;

5. Providing a wide range of product packaging configurations such as preblends and mixed blends of fruit or vegetable juice concentrates in various sized containers, juice concentrates packed aseptically in containers suitable for the food service industry, aseptically packed juices in P.E.T. bottles for both private and brand label consumer retail sales, and other forms of juice preparation and packaging as are well known in the retail consumer industry.

It is another object of this invention to provide a wide variety of consistent and accurately blended fruit or vegetable juices which are blended with other juice blends obtained from both locally grown sources and from world-wide grown sources of fruit to eliminate the seasonal effect of quality variation in both juice concentrates and juice blends.

It is still another object of this invention to provide an improved method of processing fruit into fruit juice concentrates, fruit juices and fruit juice blends of high quality and consistency, in a broad range of varieties and packagings all from a single site plant facility.

In accordance with these and other objects which will become apparent hereinafter, the instant invention will now be described with reference to the accompanying drawings.

### BRIEF DESCRIPTION OF THE DRAWINGS

FIG. 1 is a schematic view of one embodiment of the one-site plant facility of the present invention showing both equipment and the preferred seriatim flow of events therethrough.

FIG. 2 is a schematic view of another embodiment of the invention showing the addition of a water recovery arrangement and a pressed juice “not-from-concentrate” (NFC) bypass.

FIG. 3 is a schematic view of a simplified version of the invention depicting the initial juice extraction stages as a single process.

FIG. 4 is a schematic view of still another embodiment of the invention wherein the unblended juice is received into the facility from an outside source ready for blending.

### DETAILED DESCRIPTION OF THE INVENTION

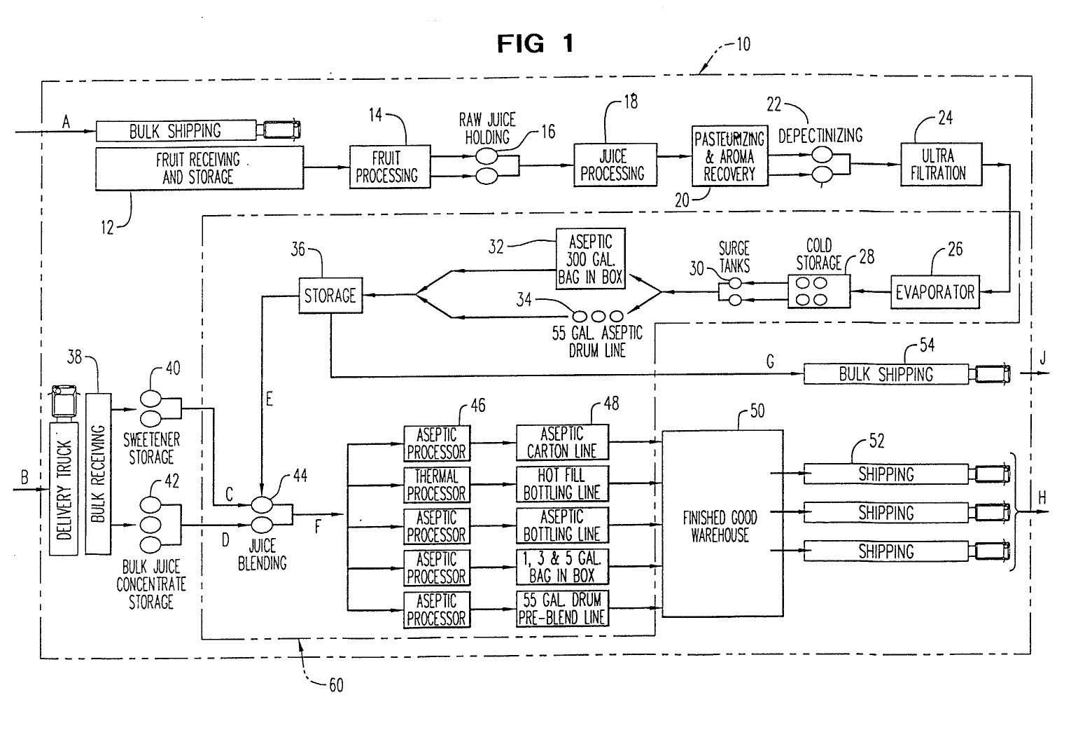

Referring now to FIG. 1, the invention is shown generally at numeral 10 within the phantom boundary intended to represent a single site facility and enclosure. Raw fruit obtained from local sources is received into the facility 10 at a fruit receiving and storage station 12 in the direction of arrow A. This station 12 is intended to receive delivery trucks and to offload the fresh-picked fruit. In automated fashion, the fresh-picked fruit is then moved along into a fruit processing station 14 within which the fruit is finely crushed into a gelatinous mass and stored within the raw juice holding tanks 16.

Thereafter, the fruit mash is automatically forwarded to a juice processing station 18 wherein fruit juice is extracted from the fruit mash by preheating and enzyme treating and aroma stripped at 20, followed by depectizing the fruit juices at 22. The fruit juice is then automatically forwarded for ultrafiltration at station 24.

The fruit juice is thereafter concentrated by an evaporation process at 26 followed by cold storage of the concentrated juice at 28. Surge tanks 30 are utilized to meter the cooled concentrated fruit juice into either aseptic containers of the juices at 32 or 34 for internal storage and processing or for bulk fruit concentrate shipment. Stored juices from storage area 36 are moved automatically in the direction of arrow E into a juice blending station 44 or may be loaded directly into bulk unblended concentrate shipping containers 54.

Separately in the facility 10, delivery trucks deliver bulk juice concentrate at 42 and liquid sweetener 40 from a bulk juice receiving station 38 in the direction of arrow B. These bulk juice concentrates and liquid sweeteners at 42 and 40, respectively, are metered into the juice blending station 44 in the direction of arrows D and C, respectively, to be combined with juice concentrate so that the final blended juice exits therefrom in the direction of arrow F.

A predetermined variety of simultaneous aseptic and thermal processor stations 46 each receive the blended juice. Each processor station 46, operating independently and simultaneously one to another as programmed, receives the blended fruit juice and either prepares it for thermal hot fill or for aseptic “cold ambient fill” which next occurs at the appropriate carton bottling, bagging or drumming lines 48, after which the now packaged or containerized blended fruit juices are forwarded to a finished goods warehouse 50. Shipment of the self-stable packaged or containerized blended fruit juices is accomplished at the shipping stations 52 in the direction of arrow H.

As previously described, bulk shipment of juice concentrates from the storage area 36 are accomplished directly per customer order separately from the more refined fruit juice blending stages thereafter by a separate bulk shipping station 54 in the direction of arrow J from the facility 10.

It is preferred to provide an aseptic environment 60 within the facility 10 which encompasses the evaporation station 26 through the containerizing and bottling lines 48.

It is important to note that little detailed attention has been given to the individual stations and equipment contained within the facility 10 as that equipment and detailed function of each is well known. That is to say that, although state-of-the-art equipment is intended to be incorporated into each such facility 10, any newness or novelty associated with each piece of equipment or each station is otherwise well known in the art.

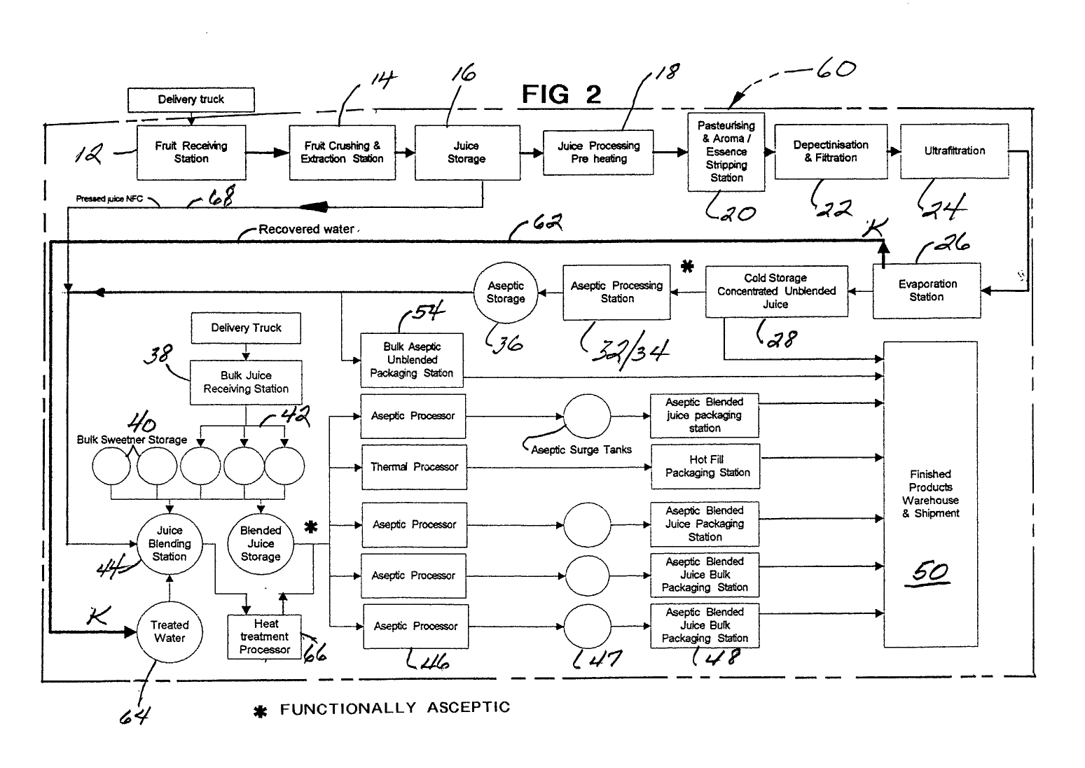

Referring now to FIG. 2, another embodiment of the invention is there shown generally at numeral 60 within the phantom boundary line intended to represent a single site facility and enclosure. Substantially all of the components and their relationships one to another are exactly the same as hereinabove described with respect to FIG. 1 and those same components are similarly numbered.

However, in this embodiment 60, there are two important and preferred additions to the invention in the form of a water recovery conduit 62 and a pressed juice not-from-concentrate (NFC) conduit 68. The recovered water conduit 68 carries removed excess water produced at the evaporation station 26 and causes it to flow to a treated water input 64 with respect to the blending station 44. This returned or recovered water is of a highly uniform and acceptable level and may be effectively utilized in the juice blending process.

The one-site facility 60 shown in FIG. 2 is further capable of processing and packaging juice product which utilizes NFC juice separated at 14 and stored at 16. This NFC juice is not passed through the downstream stages of depectinization, ultrafiltration, pasteurization or evaporation, but rather is conveyed as a single strength juice still having some of the natural cells and fiber of the original fruit product contained therein to provide the end blended juice with a more natural and fresh taste and appearance. After blending at 44, the blended juice is presterilized at 66 wherein the blended juice is heated to a temperature of up to about 95° C. and held there for approximately thirty seconds and then cooled for non-aseptic downstream packages to 20° C. or down as low as 4° C. where the juice has no preservatives.

This embodiment 60 further includes the more limited and strictly functional aseptic features which extend between the two “^{*}” marks adjacent the aseptic processing station 32/34 and at the blended juice storage container which receives the blended juice ready for aseptic packaging at 46. All of the functional interior surfaces of the equipment between the two “^{*}” marks are maintained in an aseptic condition. That is to say that only where the flowing juice comes in contact with interior surfaces is the aseptic condition maintained or where the juice might come in contact with the atmosphere. To accomplish the limited aseptic conditions for this portion of the system 60, stainless steel pipe work and necessary valves and fittings ar eused to interconnect the tanks and processes. These components are aseptically sealed from the manufacture. The surrounding environment within these components is maintained in an aseptic condition. Moreover, the tanks and the necessary venting and all connections are aseptically operated and sealed. Thus, the local environment and atmosphere are preventing from entering the enclosure pipe work and tank systems and any necessary transfers to the external environment are made via aseptic barriers which protect the system and connections and are embedded on the devices. All plant and processes prior to this area may be operated in a normal sanitary environment and do not need to be aseptic but will be maintained as cleaned and sanitized and do not need to achieve an aseptic condition. This embodiment of the aseptic standard maintained in this invention is therefore more economically achieved by the above-described approach.

The heat treatment processor at stage 66 is also utilized when the unblended juices flow into the juice blending station 44 from the aseptic storage stage 36. Each of the facilities described herein will be processing local fruits and vegetables from many geographic areas and, as a result, potential problems arise with respect to contaminated raw fruits and vegetables received into the facility. Spores and fungi infected into the fruit carried from the orchard are able to survive pre-aseptic extraction, concentration and aseptic processes because the time duration for these stages is normally too short.

The net result is that these contaminations of spores and fungi are vegetative, i.e. they manage to survive some short heat/time treatment and, when packed aseptically as blended juice at a temperature typically in the range of 25° C. to 30° C. in the final aseptic packaging stage described hereinabove, begin to incubate at this ideal temperature for doing so. The result is so called “gas formers” which cause the sealed juice packages to swell and even explode in serious cases during their storage and distribution.

This risk is eliminated or at least substantially reduced by the preheat treatment processor 66 which elevates the temperature of the blended juice somewhat higher and maintains it at that higher temperature for longer duration. Typical temperatures range between 60° C. and 100° C. and are maintained there for in the range of one to ten minutes. By incorporating this preheated stage, virtually all risk of vegetative spores and fungi becoming gas formers in the final packaged blended juice product is eliminated.

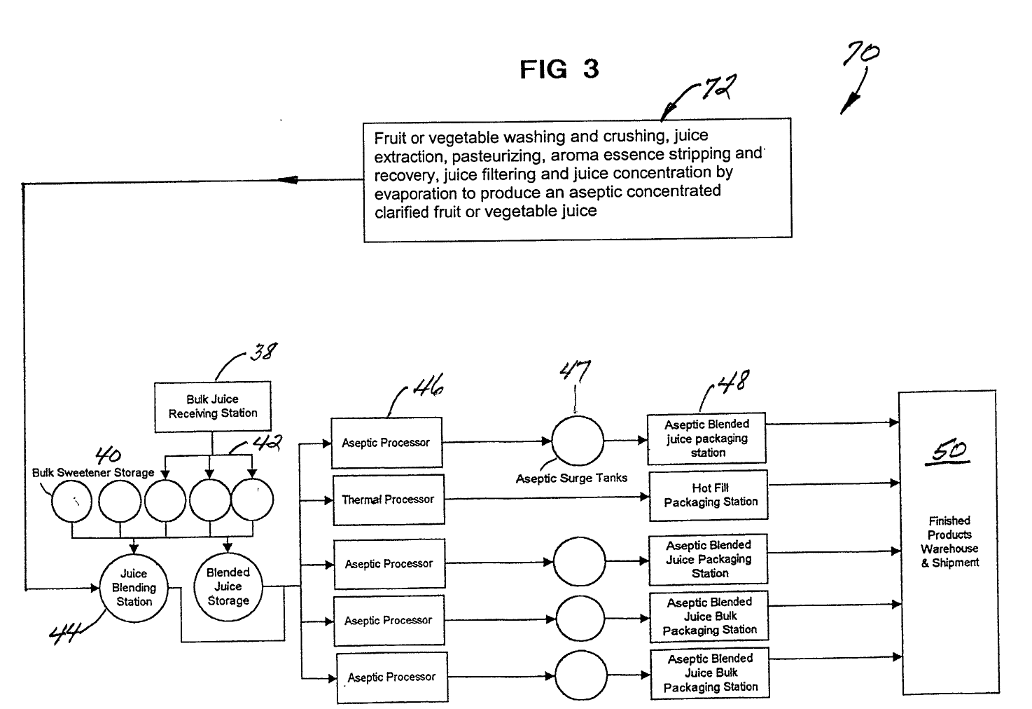

Turning briefly to FIG. 3, another schematic view of the invention is there shown generally at numeral 70 depicting the initial stages of raw fruit processing in order to deliver an unblended aseptic juice into the juice blending station 44. All of these initial activities are summarized at numeral 72.

This embodiment 70 further discloses the use of aseptic surge tanks shown typically at 47 which serve as an accumulation buffer to insure steady flow of aseptic blended juice into the juice packaging stations 48 as previously described.

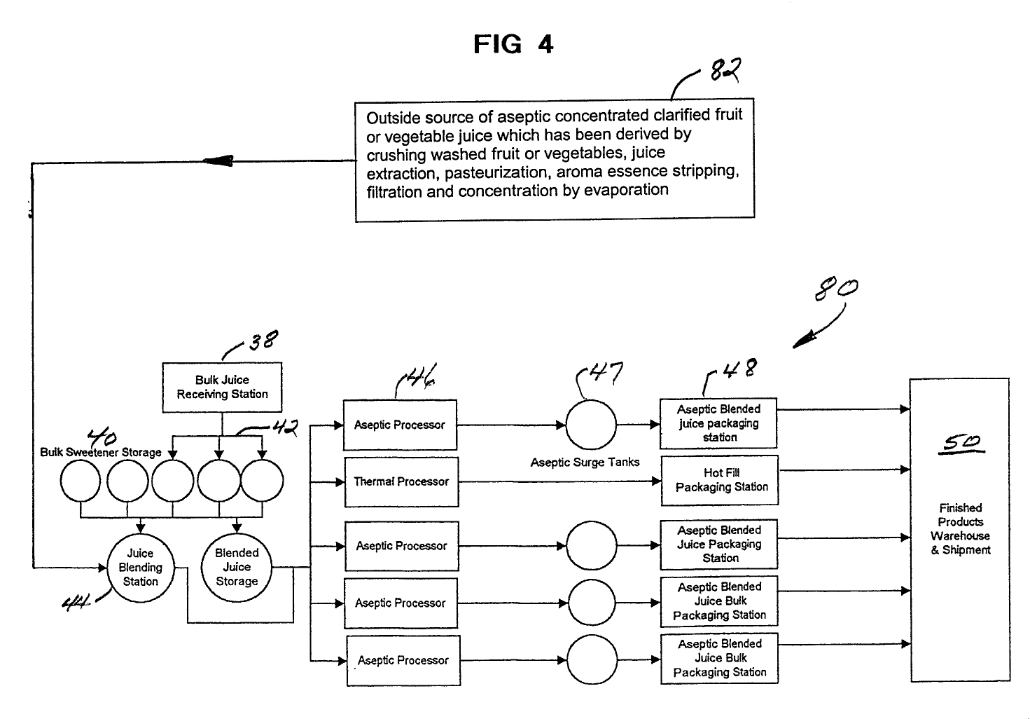

Lastly in FIG. 4, in certain circumstances the unique benefits of the invention are derived by acquiring unblended aseptic concentrated clarified fruit or vegetable juice at 82 which has been derived by the stages of initial juice processing previously described except that this juice is purchased from an outside source and delivered directly into the juice blending station 44 or held in suitable aseptic tanks prior to its utilization at the blending station 44. The arrangement shown generally at numeral 80, then, utilizes the same blending and packaging stages as described in FIG. 3, again, with the exception that the unblended juice delivered into the juice-blending station 44 has been purchased from an outside source meeting the predetermined quality standards of concentration, clarity, aseptic conditions and aroma essence stripping.

In general it is important to note that the present invention as a one-site juice blending facility is as hereinabove described adaptable to a broad range of fruits and vegetables of both high acid and low acid content. This results in the ability to blend a great range of fruit and vegetable juice products, even juices which are blended using derivatives of dairy products for unique taste and content.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

What is claimed is:

1. A one-site fruit or vegetable processing and fruit or vegetable juice packaging facility comprising:
a single extended building enclosure comprising:
a fruit or vegetable receiving stage for receiving fruit or vegetable shipments;
a fruit or vegetable crushing stage for finely crushing fruit or vegetable received from said fruit or vegetable shipment receiving stage to produce a fruit or vegetable mash;
a juice extraction stage for extracting juice from the fruit or vegetable mash;
a juice pasteurizing stage for pasteurizing and aroma essence stripping of juice received from said juice extraction stage;
a juice depectizing and filtration stage for filtration of juice received from said juice pasteurizing stage;
an evaporator stage for recovering excess water from juice received from said juice filtration stage;
a bulk packaging stage for placing a first portion of concentrated unblended juice received from said evaporator stage into bulk shipment containers ready for shipment and for placing a second portion of the concentrated unblended juice into storage containers;
a juice blending stage for combining concentrated unblended juice from said storage containers with one or more separate fruit or vegetable juice concentrates and additives to produce a desired blended juice;
a plurality of independent blended juice processors including an aseptic processor for insuring that a portion of blended juice received from said juice blending stage is sterilized and maintained at a preselected cold-ambient fill temperature and a thermal processor acting independently of and simultaneously with said aseptic processor for insuring that another portion blended juice received from said juice blending stage is sterilized and maintained at a preselected elevated temperature;
a plurality of independent aseptic blended juice packaging stages each acting independently and simultaneously of one another and receiving aseptic blended juice from one of said processors for packaging or containerizing the corresponding aseptic blended juice into predetermined self-stable containers ready for shipment.

2. A one-site fruit or vegetable processing and fruit or vegetable juice packaging facility as set forth in claim 1, wherein:
all interior surfaces of said evaporation stage, said bulk packaging stage, said juice blending stage, said blended juice processors, and said blended juice packaging stages are maintained in an aseptic condition with respect to direct contact with juice flowing therethrough.

3. A one-site fruit or vegetable processing and fruit or vegetable juice packaging facility as set forth in claim 1, wherein:
said excess water produced at said evaporator stage is recovered for use at said juice blending stage.

4. A one-site fruit or vegetable processing and fruit or vegetable juice packaging facility as set forth in claim 1, further comprising:
a preheating stage for heating blended juice to a temperature and for a time sufficient to destroy substantially all spores and fungi in the blended juice before reaching said packaging stage.

5. A one-site fruit or vegetable processing and fruit or vegetable juice packaging facility as set forth in claim 1, further comprising:
a bypass conduit connected between said juice extraction stage and said juice blending stage for selectively initiating the flow of pressed (NFC) juice from said juice extraction stage to said juice blending stage.

6. A method of processing and packaging fruit or vegetable at a single-site plant facility comprising the steps of:
A. crushing fruit or vegetable to produce a fruit or vegetable mash, extracting juice from said fruit or vegetable mash, pasteurizing and aroma essence stripping said juice to produce aseptic juice;
B. microfiltrating said aseptic juice;
C. concentrating said aseptic juice by evaporating excess water from said aseptic juice;
D. placing a portion of concentrated aseptic juice into bulk shipment containers ready for shipment;
E. blending a remaining portion of concentrated aseptic juice with one or more other separate fruit or vegetable juice concentrates and additives to produce a desired blended juice;
F. providing a plurality of independent substantially simultaneously acting processors to treat the blended juice, said plurality of processors including an aseptic processor and a thermal processor;
G. aseptically treating a portion of the blended juice at a preselected cold-ambient fill temperature within said aseptic processor;
H. independently and substantially thermally sterilizing another portion of the blended juice at a preselected elevated temperature within said thermal processor;
I. providing a plurality of independent substantially simultaneously acting blended juice packaging stages;
J. packaging aseptic blended juice at said stages from each said aseptic and thermal processor into predetermined self-stable containers ready for shipment.

7. The method of claim 6, wherein:
said steps C through E are carried out in a substantially aseptic environment with respect to the fruit juice coming in contact with equipment or atmosphere.

8. The method of claim 6, further comprising the step of:
K. recovering said excess water produced during step C for use in step E.

9. The method of claim 6, further comprising the step of:
L. selectively bypassing steps B to E and blending raw juice produced during step A with one or more other separate juice concentrates and additives to produce another desired blended juice.

10. The method of claim 6, further comprising the step of:
M. preheating said blended juice to a temperature and for a time sufficient to destroy substantially all spores and fungi in said blended juice before step G.

11. A fruit or vegetable processing and packaging facility comprising:
a single extended building enclosure;
a fruit or vegetable receiving stage of said enclosure for receiving raw fruit or vegetable shipments;
a fruit or vegetable crushing stage within said enclosure and in proximity to said fruit or vegetable receiving stage for finely crushing fruit or vegetable received from said fruit or vegetable receiving stage to produce a fruit or vegetable mash;
a juice extraction stage within said enclosure for extracting juice from the fruit or vegetable mash received from said fruit or vegetable crushing stage;
a juice pasteurizing stage within said enclosure for pasteurizing and aroma essence stripping of juice received from said juice extraction stage;
a juice filtration stage within said enclosure for microfiltration of juice received from said juice pasteurizing stage;
a juice concentrating stage within said enclosure for evaporating excess water from aseptic juice received from said juice filtration stage;
a bulk juice packaging stage within said enclosure for placing a portion of concentrated aseptic juice received from said juice concentrating stage into bulk shipment containers ready for shipment from a bulk shipping stage of said enclosure in proximity to said bulk packaging stage;
a juice blending stage within said enclosure for blending concentrated aseptic juice received from said juice concentration stage with one or more other separate fruit or vegetable juice concentrates and additives to produce a desired blended juice;
one or more aseptic processors within said enclosure for sterilizing and maintaining blended juice received from said juice blending stage at a preselected cold-ambient fill temperature;
one or more thermal processors acting independently and simultaneously with said aseptic processor within said enclosure for sterilizing and maintaining blended juice received from said juice blending stage at a preselected elevated temperature;
a plurality of blended juice packaging stages within said enclosure each acting independently and simultaneously of one another and separately receiving blended juice from each said processors and packaging blended juice into predetermined self-stable containers ready for shipment from a finished goods shipping stage of said enclosure in proximity to said packaging stages.

12. A one-site fruit or vegetable processing and fruit or vegetable juice packaging facility as set forth in claim 11, wherein:
said juice concentrating stage, said bulk packaging stage, said juice blending stage, said processors, and said packaging stage are substantially aseptic.

13. A one-site fruit or vegetable processing and fruit or vegetable juice packaging facility as set forth in claim 11, further comprising:
a preheating stage for heating blended juice to a temperature and for a time sufficient to destroy substantially all spores and fungi in the blended juice before reaching said packaging stage.

14. A one-site fruit or vegetable processing and fruit or vegetable juice packaging facility comprising:
a single extended building enclosure comprising:
a fruit or vegetable juice receiving stage for receiving aseptic concentrated clarified and unblended fruit or vegetable juice shipments;
a juice blending stage for combining said juice with one or more separate fruit or vegetable juice concentrates and additives to produce a desired blended juice;
a plurality of independent blended juice processors including an aseptic processor for insuring that a portion of blended juice received from said juice blending stage is sterilized and maintained at a preselected cold-ambient fill temperature and a thermal processor acting independently of and simultaneously with said aseptic processor for insuring that another portion blended juice received from said juice blending stage is sterilized and maintained at a preselected elevated temperature;
a plurality of independent aseptic blended juice packaging stages each acting independently and simultaneously of one another and receiving aseptic blended juice from one of said processors for packaging or containerizing the corresponding aseptic blended juice into predetermined self-stable containers ready for shipment.

15. A one-site fruit or vegetable processing and fruit or vegetable juice packaging facility as set forth in claim 14, further comprising:
a preheating stage for heating blended juice to a temperature and for a time sufficient to destroy substantially all spores and fungi in the blended juice before reaching said packaging stage.

16. A method of processing and packaging fruit or vegetable at a single-site plant facility comprising the steps of:
A. receiving bulk quantities of aseptic concentrated clarified and unblended juice;
B. blending said unblended juice with one or more other separate fruit or vegetable juice concentrates and additives to produce a desired blended juice;
C. providing a plurality of independent substantially simultaneously acting processors to treat the blended juice, said plurality of processors including an aseptic processor and a thermal processor;
D. preheating said blended juice to a temperature up to about 132° C. for a time sufficient to destroy spores and fungi in said blended juice which otherwise cause gas to form in aseptically packaged blended juice;
E. aseptically treating a portion of the blended juice at a preselected cold-ambient fill temperature within said aseptic processor;
F. independently and substantially thermally sterilizing another portion of the blended juice at a preselected elevated temperature within said thermal processor;
G. providing a plurality of independent substantially simultaneously acting blended juice packaging stages;
H. packaging aseptic blended juice at said stages from each said aseptic and thermal processor into predetermined self-stable containers ready for shipment.
